(19) United States
(12) Patent Application Publication
(10) Pub. No.: US 2007/0156601 A1
(43) Pub. Date: Jul. 5, 2007

(54) Method and system for providing interoperability between digital rights management systems

(75) Inventors: Glenn Edwards Brew, Boca Raton, FL (US); Douglas Richard Geisler, Boca Raton, FL (US); Marco M. Hurtado, Boca Raton, FL (US); Michael G. Lisanke, Durham, NC (US); James Christopher Mahlbacher, Lake Worth, FL (US); Joseph Cesare Polimeni, Parkland, FL (US)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/324,880

(22) Filed: Jan. 3, 2006

(51) Int. Cl. G06Q 99/00

(52) U.S. Cl. 705/57

(57) ABSTRACT

Methods and apparatus for managing digital content in content management system are provided. The content management system includes a filter operable to automatically determine a first protected format of digital content that has been imported into the content management system, and a transformer operable to transform the digital content from the first protected format into a second protected format. The second protected format is different from the first protected format.

### FIELD OF THE INVENTION

The present invention relates generally to digital communications, and more particularly to digital rights management.

### BACKGROUND OF THE INVENTION

An enterprise content management system is a business solution that can typically manage all types of digital information (or digital content) including, for example, HTML and XML Web content, document images, electronic office documents, printed output, audio, and video. Conventional enterprise content management system can generally protect digital information that is sensitive or confidential to a given business. For example, users of an enterprise content management system can declare any corporate document or information as a corporate record. Once a document is declared as a corporate record, the document cannot be edited or deleted from the enterprise content management system without proper authorization. In addition, access permissions and lifecycle of the document are governed by the access permissions and lifecycle rules defined in the enterprise content management system. Thus, only authorized users, such as the records administrators, can process or manage the life cycle of the document.

In today's growing e-business world, many businesses are finding it increasingly important to not only use an enterprise content management system to manage and store digital content generated within the given enterprise, but also to manage and import digital content generated by a user using a third party client (e.g., third party software) into the enterprise content management system. Incorporating digital content generated using third party software into an enterprise content management system is a generally straightforward process similar to incorporating digital content generated within the enterprise. Users using such third party software, however, are increasingly protecting digital content using one or more (proprietary) digital rights management (DRM) systems that are associated with the third party software. A digital rights management system generally uses applied cryptography to allow a content owner to prescribe a specific use for created content. A conventional digital rights management system is a “closed” system that does not interoperate easily with other digital rights management systems, including conventional enterprise content management systems, or non-digital rights management systems. This is a result of the fact that digital rights management systems maintain persistent control over associated digital content and if interoperability were easily achieved then content protection of the digital rights management system would be easily circumvented. Examples of digital rights management systems include Microsoft Windows® Rights Management Services (RMS) available from Microsoft Corporation of Redmond, Wash., and Adobe® LiveCycle Policy Server available from Adobe Systems Incorporated of San Jose, Calif.

Accordingly, what is needed is an enterprise content management system that provides a set of integration services for third party content protection systems (or third party software), ranging from encryption to digital rights management. The present invention addresses such a need.

### BRIEF SUMMARY OF THE INVENTION

In general, in one aspect, this specification describes a content management system including a filter operable to automatically determine a first protected format of digital content that has been imported into the content management system, and a transformer operable to transform the digital content from the first protected format into a second protected format. The second protected format is different from the first protected format.

Particular implementations can include one or more of the following features. The method can further include storing the digital content in the content management system in accordance with the second protected format, and encrypting the stored digital content. Storing the digital content can include storing the digital content in a plurality of different formats that correspond to a plurality of digital rights management systems supported by the content management system. Storing the digital content can include storing the digital content in the clear to permit an index search or text search on the stored digital content. The method can further include exporting the digital content from the content management system in any one of the plurality of formats, including exporting the digital content in the clear.

The method can further include applying a digital signature to the digital content imported into the content management system for authenticating the imported digital content. Automatically determining a first protected format of digital content can include applying one or more algorithms to the digital content to detect a characteristic that is unique to a digital rights management system. Automatically determining a first protected format of digital content can also include applying one or more method calls, in which each method call corresponds to a particular digital rights management system supported by the content management system. The method can further include transcoding the digital content imported into the digital rights management from one format into another. Transforming the digital content from the first protected format into a second protected format can include using pre-established credentials established with digital rights management systems supported by the enterprise content management system. The pre-established credentials can give the content management system one or more ownership rights in the digital content imported into the content management system. The digital content can comprise one or more of the HTML and XML Web content, document images, electronic office documents, printed output, audio, and video.

In general, in another aspect, this specification describes a computer program product, tangibly stored on a computer readable medium, for transforming digital content in a content management system. The product comprises instructions to cause a programmable processor to automatically determine a first protected format of digital content that has been imported into the content management system, and transform the digital content from the first protected format into a second protected format. The second format is different from the first protected format.

In general, in another aspect, this specification describes a content management system including a filter operable to automatically determine a first protected format of digital content that has been imported into the content management system, and a transformer operable to transform the digital content from the first protected format into a second protected format. The second protected format is different from the first protected format.

Implementations may provide one or more of the following advantages. An enterprise content management system is disclosed that provides interoperability between multiple different (proprietary) digital rights management systems. Because the enterprise content management system can transform digital content into many different types of digital rights management formats, an end-user need only to have one particular type of digital rights management software that is supported by the enterprise content management system. Such transformation capability of DRM content between multiple digital rights management formats provides for improved efficiency and lower costs associated with licensing specific digital rights management software. Additionally, the methods provided in this specification provide an efficient, robust, and dynamically configurable means to transform digital content within the enterprise content management system.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 is a block diagram of a data processing system including an enterprise content management system in accordance with one implementation of the invention.

FIG. 2 is a block diagram illustrating the enterprise content management system of FIG. 1 in accordance with one implementation of the invention.

FIG. 3 illustrates a method for receiving digital content into the enterprise content management system of FIG. 1 in accordance with one implementation of the invention.

FIG. 4 illustrates a method for exporting digital content from the enterprise content management system of FIG. 1 in accordance with one implementation of the invention.

FIG. 5 illustrates services of the enterprise content management system of FIG. 1 including a transformer service, a content and user ID mapper, and an XACML policy service in accordance with one implementation of the invention.

FIG. 6 illustrates a block diagram of the transformer service of FIG. 5 in accordance with one implementation of the invention.

FIG. 7 illustrates a UML class diagram for transforming digital content from one digital rights management format into another in accordance with one implementation of the invention.

FIG. 8 illustrates method calls for transforming digital content as digital content is received by an enterprise content management system in accordance with one implementation of the invention.

FIG. 9 illustrates a block diagram of the XACML policy service of FIG. 5 in accordance with one implementation of the invention.

FIG. 10 is a block diagram of a data processing system suitable for storing and/or executing program code in accordance with one implementation of the invention.

Like reference symbols in the various drawings indicate like elements.

### DETAILED DESCRIPTION OF THE INVENTION

Implementations of the present invention relates generally to digital communications, and more particularly to digital rights management. The following description is presented to enable one of ordinary skill in the art to make and use the invention and is provided in the context of a patent application and its requirements. Various modifications to implementations and the generic principles and features described herein will be readily apparent to those skilled in the art. Thus, the present invention is not intended to be limited to the implementations shown but is to be accorded the widest scope consistent with the principles and features described herein.

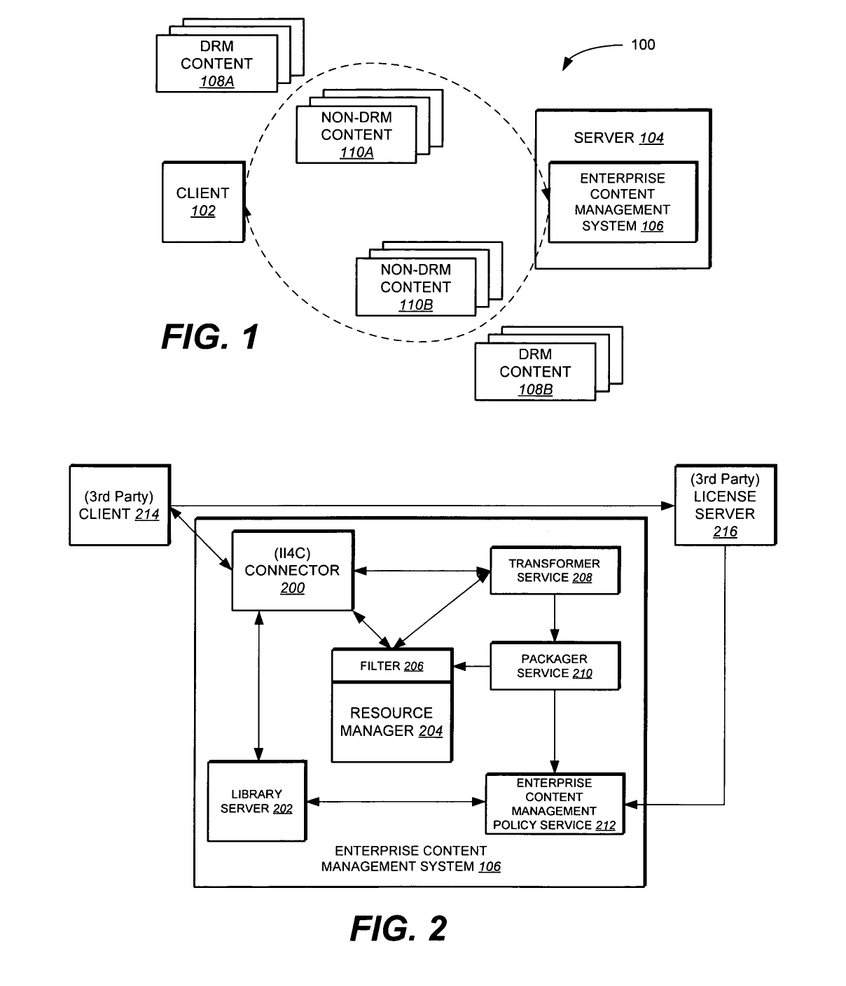

FIG. 1 illustrates a data processing system 100 including a client 102 and a server 104 in accordance with one implementation of the invention. Although data processing system 100 is shown as including one client and one server, data processing system 100 can include any number of clients and servers. Data processing system 100 can have any number and types of computer systems, including for example, a workstation, a desktop computer, a laptop computer, a personal digital assistant (PDA), a cell phone, a network, and so on. Data processing system 100 includes an enterprise content management system 106 that (in one implementation) is stored on server 104. Enterprise content management system 106 can be an enterprise software solution, such as DB2 Content Manager, available from International Business Machines of Armonk, N.Y., or other content management system.

Unlike conventional enterprise content management systems, enterprise content management system 106 supports different types of digital rights management systems and, therefore, enterprise content management system 106 can be used to manage and store digital content created from the different types of digital rights management systems. For example, a user can import digital content into enterprise content management system 106 that has been protected (or packaged) in accordance with one particular digital rights management system, and the same or other user can retrieve the same digital content from enterprise content management system 106 protected in accordance with another digital rights management system. More generally, enterprise content management system 106 can receive protected digital content (e.g., DRM content 108A) and/or non-protected digital content (e.g., non-DRM content 110A) and export protected digital content (e.g., DRM content 108B) and/or non-protected digital content (e.g., non-DRM content 110B). Accordingly, enterprise content management system 106 provides a single, controllable, and centralized point of interoperability between multiple digital rights management systems.

Additionally, in one implementation, enterprise content management system 106 can store the same digital content in accordance with a plurality of different digital rights management formats that corresponds the digital rights management systems supported by enterprise content management system 106. Enterprise content management system 106 can also store digital content in the clear, for example, to permits users to have access to search terms and/or index terms when performing a search for specific digital content.

In addition, because many enterprises want to ensure that digital content is protected while the digital content is stored on a server (e.g., server 104), in one implementation, enterprise content management system 106 is a (server-side) content protection system that also makes use of encryption to protect digital content. Enterprise content management system 106 can also maintain a centralized access control list (ACL) that is used to protect (or control the access to) the digital content stored in enterprise content management system 106. Generally, ACLs identify which users may access specific digital content, and identify the type of access that a user has for the specific digital content. Various types of access (or permissions) may be granted to a user directly or through a group, such as, for example, delete (may delete object), execute (may execute object), read (may read object), write (may change object), create (may create new objects), permissions (may change ACL of object), attributes (may change attributes other than ACL), and the like.

In one implementation, enterprise content management system 106 includes a filter (not shown) for determining how received digital content has been packaged—i.e., which particular digital rights management system was used to protect the received digital content, and a transformer (not shown) for transforming digital content from one given format of protection to another. The transformer can negotiate with a license server of a particular digital rights management system (e.g., a third party license server) to unprotect (or unpackage) or protect digital content imported into enterprise content management system 106. The filter and the transformer are discussed in greater detail below.

As discussed above, conventional digital rights management systems are typically closed systems that do not interoperate easily with other digital rights management systems or non-digital rights management systems. Any use of protected digital content (referred to herein as DRM content), including the transfer of DRM content between digital rights management systems, must generally be explicitly authorized by a given digital right management system through respective rights expression languages (RELs). A digital rights management system REL can be interpreted by software logic associated with the digital rights management system such that each mode of use (associated with the DRM content) can be unambiguously discerned from a license containing rights associated with the DRM content.

There is a deterministic behavior for DRM content based on the conventions for executing rights contained in a license. As such, there must be a way for prescribing that DRM content may be transferred to (or imported into) another digital rights management system. Each digital rights management system REL may be different, but each has the concept of a content owner (or creator) that has complete control over uses of DRM content, including the ability to exercise the removal of protection from the DRM content. Accordingly, in one implementation, the process by which a digital rights management system gains the authority to transfer DRM content to another digital rights management system is by providing ownership rights to a transferring broker, such as enterprise content management system 106.

A general requirement imposed on digital rights management software that provides for interoperability between two different digital rights management systems is that the transformation of the license results in a predictable, unambiguous, acceptable, but not necessarily consistent treatment of DRM content. That is, the rights afforded by one digital rights management system could be relaxed or tightened in another digital rights management system as long as the result is acceptable, unambiguous, and predictable. In one implementation, the criterion for “acceptable” is that a content creator trusts enterprise content management system 106 that is identified in a digital rights management REL as an owner. This permits the content creator to transfer ownership of the DRM content to enterprise content management system 106, as well as give enterprise content management system 106 the right to set policies (or rights) for the DRM content.

Enterprise content management system 106 generally solves the problem of interoperability between multiple digital rights management systems by providing a means to transfer control of DRM content in a trusted and secure environment. Thus, in one implementation, content owners and creators, associated with enterprise content management system 106, can have a business relationship in which prescribing content use policy of DRM content is a shared responsibility. In one implementation, a policy includes one or more rights that govern the interaction between a user and digital content.

By providing processes (e.g., through enterprise content management system 106) in a backend server (e.g., server 104 in one implementation) to authenticate and gain authorization to DRM content in the clear, enterprise content management system 106 can transform DRM content to achieve interoperability between multiple digital rights management systems. For example, in a case where multiple users of enterprise content management system 106 each implement a different digital rights management system, each user can retrieve digital content from enterprise content management system 106 no matter the initial particular format of DRM content. More specifically, enterprise content management system 106 can export digital content to each user in a format required by the digital rights management system associated with the user. Such transformation capability of DRM content between multiple digital rights management formats provides for improved efficiency and lower costs associated with licensing specific digital rights management software.

FIG. 2 illustrates one implementation of enterprise content management system 106 in greater detail. As shown in FIG. 2, enterprise content management system 106 includes a connector 200, a resource manager 202, and a library server 204.

In one implementation, connector 200 is an Information Integrator for Content (II4C) connector that provides broad information integration for enterprise portals, relational databases, business intelligence, and enterprise content management applications. The II4C connector lets (business) users personalize data queries, search extensively for very specific needs, and utilize relevant results across both traditional and multimedia data sources. For developers, the II4C connector enables rapid portal application development and deployment. The II4C connector additionally provides an enhanced foundation for access to both structured data (stored in library server 202) and unstructured data (stored in resource manager 204), including digital content generated from within an enterprise and digital content generated from third parties. In one implementation, connector 200 comprises a set of application programming interfaces (APIs) (e.g., in JAVA or C) that permits a user to interact with library server 202 and resource manager 204. Examples of unstructured data that can be stored in resource manager 204 include JPEG (Joint Photographic Experts Group) images and BMP (bitmap) images, and examples of structured data that can be stored in library server 204 include references, attributes, and/or metadata associated with the JPEG images and BMP images stored in resource manager 204. Generally, connector 200 isolates library server 202 from resource manager 204, and provides a means for permitting users to manage (e.g., retrieve, import, update, or remove) digital content within enterprise content management system 106.

Enterprise content management system 106 further includes a filter 206, a transformer service 208, a packager service 210, and an enterprise content management policy service 212.

Filter 206 determines a type of protection that has been applied to DRM content that has been imported into enterprise content management system 106 by a user. Conventional digital rights management systems typically use proprietary formats such that one digital rights management system will not be able to interpret a file that has been protected (or encoded) by another digital rights management system. Thus, in one implementation, filter 106 applies a series of algorithms to digital content that detects a characteristic that is unique to digital rights management systems known to filter 106. For example, one algorithm that can be used to identify a unique characteristic associated with a digital rights management system includes scanning the beginning of a digital stream comprising imported digital content to identify a bit pattern that associates the imported digital content with a particular digital rights management system. Accordingly, the beginning of a digital stream can be used as a characteristic to identify digital content as being formatted in accordance with a particular digital rights management system. Other types of unique characteristics can be used by filter 106 for determining a type of protection applied to DRM content. In another implementation, filter 206 calls methods (or digital rights management APIs) for the different digital rights management systems (supported by enterprise content management system 106) against imported digital content, and which ever method succeeds in, e.g., accessing the digital content will determine the type of protected that as been applied to DRM content.

In one implementation, filter 206 maintains a list of supported digital rights management systems and corresponding unique identifiers (content IDs) that are assigned to each of the supported digital rights management system. In this implementation, when a particular digital rights management format is detected, filter 206 associates the unique identifier (that has been pre-assigned to the particular digital rights management format) to the corresponding digital content. Filter 206 can persist the “state” of the digital content, as well as the associated unique identifier, in library server 202 for later use by other components within enterprise content management system 106, e.g., transformer service 208.

In one implementation, transformer service 208 determines what transformations should be applied to digital content as digital content is imported and exported from enterprise content management system 106. For example, DRM content (in accordance with a first digital rights management format) received by enterprise content management system 106 may need to be stored according to a second digital rights management format as specified in enterprise content management policy service 212. Also, digital content stored within enterprise content management system 106 may need to be transformed to a particular digital rights management format associated with a particular user. In one implementation, transformer service 208 maintains a list of digital rights management systems associated with each user (or client) of enterprise content management system 106 (e.g., in a content ID repository). In this implementation, when digital content is exported from enterprise content management system 106 to a particular user, transformer service 208 can determine what types of transformations need to be performed on digital content based on a current state of the digital content and a digital right management format required by the particular user.

Transformer service 208 generally transforms digital content in enterprise content management system 106 from one format into another format. Tranformer service 208 can transform digital content from a non-protected format into a protected format, transform digital content from a protected format into a non-protected format, and transform digital content from one protected format into another protected format. In one implementation, transformer service 208 uses packager service 210 to unpackage (or unprotect) digital content or to package (or protect digital) content. In one implementation, packager service 210 (through XACML (extensible Access Control Markup Language) policy service 504, discussed in greater detail below) unpackages or packages digital content in accordance with (third party) policies or licenses set forth within a third party license server 216. Packager 210 can also unpackage or package digital content in accordance with (enterprise) policies or licenses set forth within enterprise content management policy service 212. Transformer service 208 can also transcode digital content from one format into another. For example, transformer service 208 can transcode a BMP (bitmap) file into a JPEG file. In one implementation, transformer service 208 can further encrypt digital content and formulate digital signatures. The digital signatures permit digital content stored in enterprise content management system to be authenticated. Furthermore, encryption can protect raw data associated with digital content stored in enterprise content management system should a user try to access the digital content separate from access methods provided by enterprise content management system 106.

In one implementation, enterprise content management system 106 further includes a third party client 214 that provides public APIs (application programming interfaces) which third parties can code to in order integrate their digital rights management systems within the framework of enterprise content management system 106.

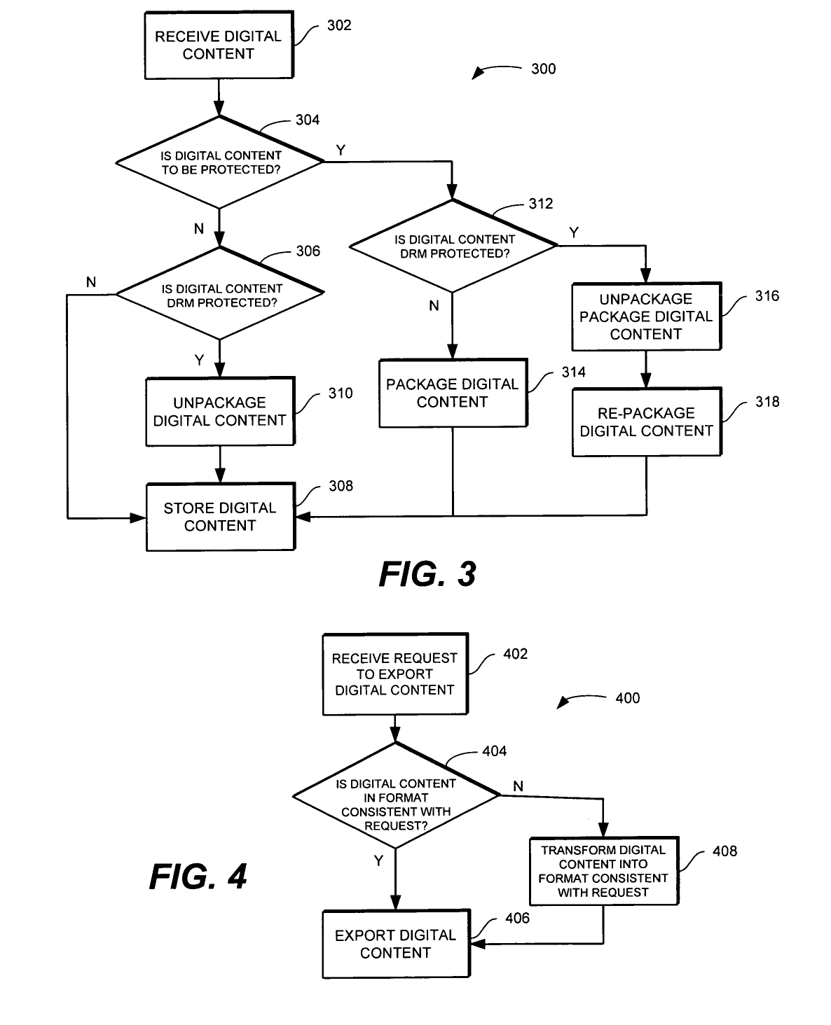

FIG. 3 illustrates a method 300 for importing digital content into an enterprise content management system (e.g., enterprise content management system 106). Digital content is received (step 302). In one implementation, the digital content is received by the enterprise content management system through a connector (e.g., connector 200) from a client (e.g., client 214). The client can be a client associated within an enterprise, or the client can be a third party client. In addition, the received digital content can be DRM protected or non-DRM protected. In one implementation, the digital content is received as a stream or as a uniform resource locator (URL) to a stream. A determination is made as to whether the digital content is to be protected within the enterprise content management system (step 304). In one implementation, the determination as to whether digital content is to be protected or not is specified by policies and licenses set forth within an enterprise content management policy service (e.g., enterprise content management policy service 212) of the enterprise content management system. The determination can also be specified through a third party license server (e.g., third party license server 216) communicating with an enterprise content management policy service (e.g., enterprise content management policy service 212).

If it is determined that the digital content is not to be protected in step 304, then a determination is made as to whether the digital content is in a protected state by a filter (e.g., filter 206) (step 306). In one implementation, the filter itself assigns a unique identifier to digital content based on the type of protection applied to the digital content. If the digital content was received by the enterprise content management system in a non-protected state, then the digital content is stored (e.g., in resource manager 204) (step 308). If the digital content was received by the enterprise content management system is in a protected state, then the digital content is unpackaged (or unprotected) (e.g., by packager service 210) (step 310). In one implementation, the digital content is unpackaged in accordance with pre-established credentials (or rights) established with digital rights management systems supported by the enterprise content management system. The unpackaged digital content is then stored in step 306.

If it is determined in step 304 that the digital content is to be protected within the enterprise content management system, then a determination is made as to whether the digital content is in a protected state (step 312). If the digital content is in a non-protected state, then the digital content is packaged (e.g., by packager service 210) (step 314). In one implementation, the digital content is packaged (or protected) in accordance with policies or licenses set forth in the enterprise content management policy service. Alternatively, the digital content can be encrypted using conventional encryption techniques. The packaged digital content is then stored in step 308.

If it is determined in step 312 that that digital content is in a protected state, then the digital content is unpackaged (step 316) and then re-packaged in accordance with policies or licenses set forth in the enterprise content management policy service (step 318). Alternatively, if it is determined in step 312 that that digital content is in a protected state, then the digital content can be stored directly in the resource manager as-is—i.e., in the original protected state.

FIG. 4 illustrates a method 400 for exporting digital content from an enterprise content management system (e.g., enterprise content management system 106). A request to export digital content from the enterprise content management system is received (step 402). In one implementation, the request includes a request for digital content in a format specific to a particular digital rights management system. Alternatively, the enterprise content management system can determine a particular digital rights management format required by a user through information associated with a user ID or user account of the user. A determination is made as to whether the digital content is in a format consistent with the request (e.g., by filter 206) (step 404). If the digital content is in a format consistent with the request, then the digital content is exported from the enterprise content management system. If the digital content is not in a format consistent with the request, then the digital content is transformed (e.g., by transformer service 208) into a format consistent with the request (step 408). The transformed digital content is then exported from the enterprise content management system in step 406.

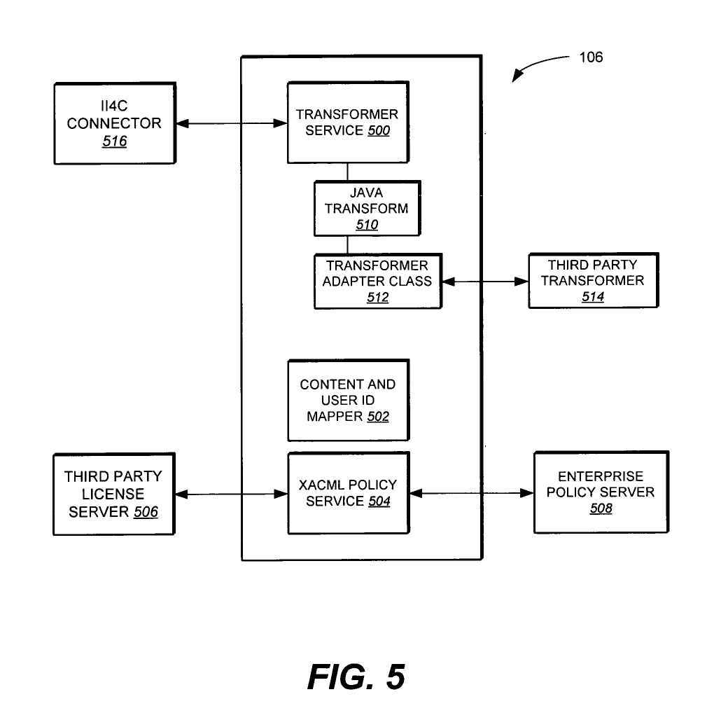

FIG. 5 illustrates services associated with enterprise content management system 106 in accordance with one implementation of the invention. In this implementation, the services includes three Enterprise JavaBeans (EJBs) that also have web service interfaces—i.e., a transformer service 500, a content and user ID mapper 502, and an XACML policy service 504. In general, transformer service 500 transforms digital content, content and user ID mapper 502 maps third party digital rights management IDs that are associated with DRM protected content to a globally unique identifier (GUID) assigned to the same digital content by enterprise management system 106, and XACML policy service 504 provides permission and attribute information (including licenses and policies) for use by enterprise content management system 106. XACML policy service 504 can also provide additional permission or attribute information to a third party license server (e.g., third party license server 506) or an enterprise license server (e.g., enterprise policy server 508). The services can be distributed on many servers or machines. Each service will now be discussed in greater detail.

Transformer Service

Transformer service 500 invokes an appropriate transformation process (represented in FIG. 5 as Java transform 510) to transform digital content from one format to another. The digital content can be provided as a stream, or provided as a URL to a stream. In one implementation, information returned by the transformation process is persisted. Each transformation process comprises one or more Java classes (represented in FIG. 5 as transformer adapter class 512) that are executed serially. If a third party application uses a web service to perform transformation of the digital content, then a third party Java class (represented in FIG. 5 as third party transformer 514) would make a call to the web service.

An unlimited number of transformation processes can be available for use. The specific transformation is generally chosen based on selection criteria describing the digital content and a current state of the digital content. In one implementation, the selection criteria used to determine which transform process will be applied is based on a mime-type of the digital content, item type (content type), a location requesting the transform, and a current state of the digital content. In one implementation, the current state describes changes that do not result in a mime-type change, but still change the content. For example, a JPEG file encrypted in accordance with the Advance Encryption Standard (AES) would be one such case in which the mime-type has not changed but the current state indicates a change. Additional factors (or unique characteristics) can be used in cases where a selection criteria (or algorithm) results in two or more matches. For example, the selection criteria may indicate that either an Adobe or Microsoft transform is required, however, with additional information (such as user preference) then it may be determined that the Microsoft transform should be performed on the digital content.

In one implementation, the transformation process configuration may be defined such that one transform process applies to many content types, mime-types, and code entry points. In addition, multiple processes may be required to transform digital content. In such a case, each process can be performed sequentially. For example, the first transformation process may decrypt the digital content, and the second transformation process may package the digital content in accordance with a format of a specific digital rights management system. In one implementation, transformer service 500 has the capability to store and retrieve metadata associated with a transformation process.

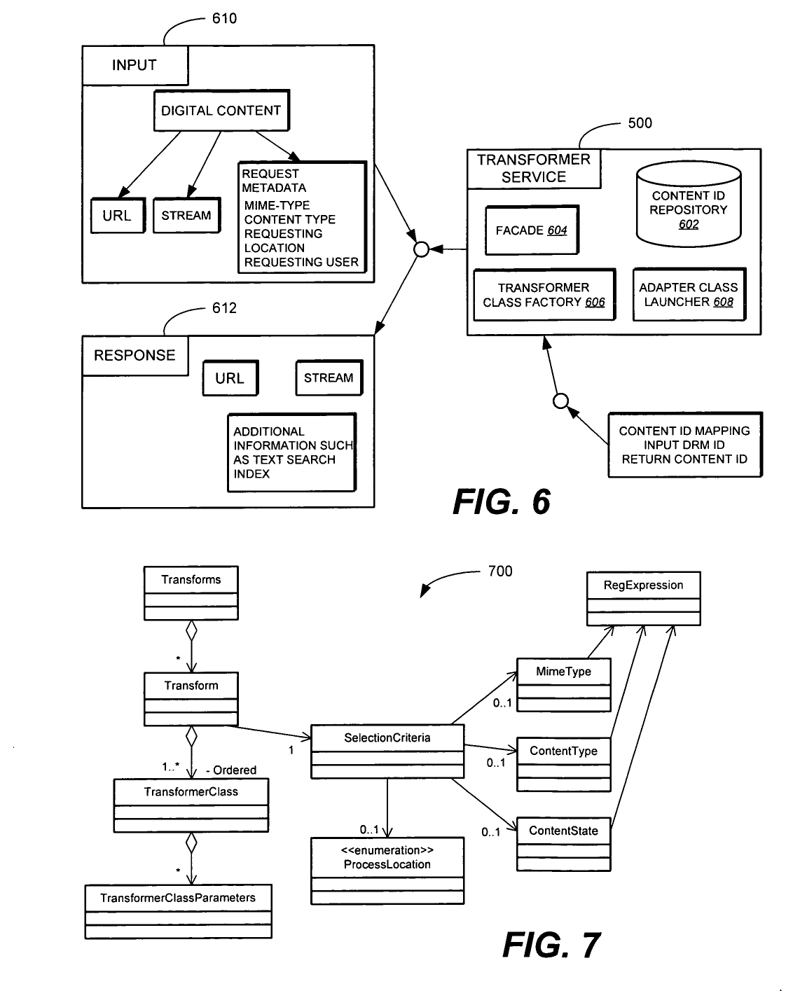

FIG. 6 illustrates internal details of transformer service 500 in accordance with one implementation. In this implementation, transformer service 500 includes a content ID repository 602, a facade 604, a transformation class factory 606, and an adapter launcher class 608. Content ID repository 602 can be used to store temporary IDs that have been assigned to digital content if, for example, a globally unique identifier has not yet been assigned to the digital content by enterprise content management system 106. Transformer class factory 606 and facade 604 can be used to create an unlimited number of transformation processes using conventional techniques. Adapter class launcher 608 can be used to invoke one or more Java classes (discussed above) that can be executed serially.

Also shown in FIG. 6 is an input 610 to transformer service 500. Input 610 represents digital content that can be in the form of a stream or a URL to a stream. Input 610, in one implementation, further includes associated request metadata including mime-type, content type, requesting location, and requesting user. Input 610 is transformed into a response 612. In one implementation, response 612 is in the form of a stream or a URL to a stream. Response 612 can also include additional information such as information related to a text search index, as illustrated in FIG. 6.

FIG. 7 illustrates a unified modeling language (UML) class diagram 700 for transforming digital content through transformer service 500. FIG. 7 shows the information used to describe which transformation processes are used according different types of selection criteria. More specifically, each transformation process is based on a selection criteria that contains an enumeration describing the process location, and values for mime-type, content type (item type), and content state. Each of these values may be described in a regular expression format so that a single transform definition may be applicable to many different values of selection criteria.

Referring back to FIGS. 2 and 5, in one implementation, the layer associated with II4C connector 516 provides a mechanism (or exit) that will be called when specific actions are performed on digital content within enterprise content management system 106. In one implementation, the provided method for transforming digital content is: public void processContent (byte[] buffer, int bytesRead, int buffersize). The method transforms digital content in segments. Each transformed segment (in one implementation) is the same length as the original segment. Transforming digital content in segments of bytes works for simple stream based encryption, however, most third party digital right management applications use block encryption, and in most cases access to all the digital content is required.

In one implementation, to efficiently transform digital content, the digital content is captured as a stream or a URL to a stream before the data is stored in resource manager 204. A servlet filter can be added to a servlet associated with resource manager 204. In one implementation, the servlet filter is installed between the servlet container and the servlet associated with resource manager 204. When a request for importing or exporting digital content is received (e.g., by a connector), the specific transformation process needs to know what action (or operation) is being performed, the mime-type, the item type, and the state (if available). Based on the information provided to the servlet filter, the transformation process knows the operation (e.g., store) and the mime-type (e.g., listed as content type), and the content ID. The transformation process does not know the state, however, for an import operation this information is not required. In order to determine the state of the digital content based on the content ID before the digital content is stored (or committed) then software code will be called (e.g., a transformer service) to determine if digital content needs to be transformed, and if so, pass the metadata along to the servlet associated with resource manager 204.

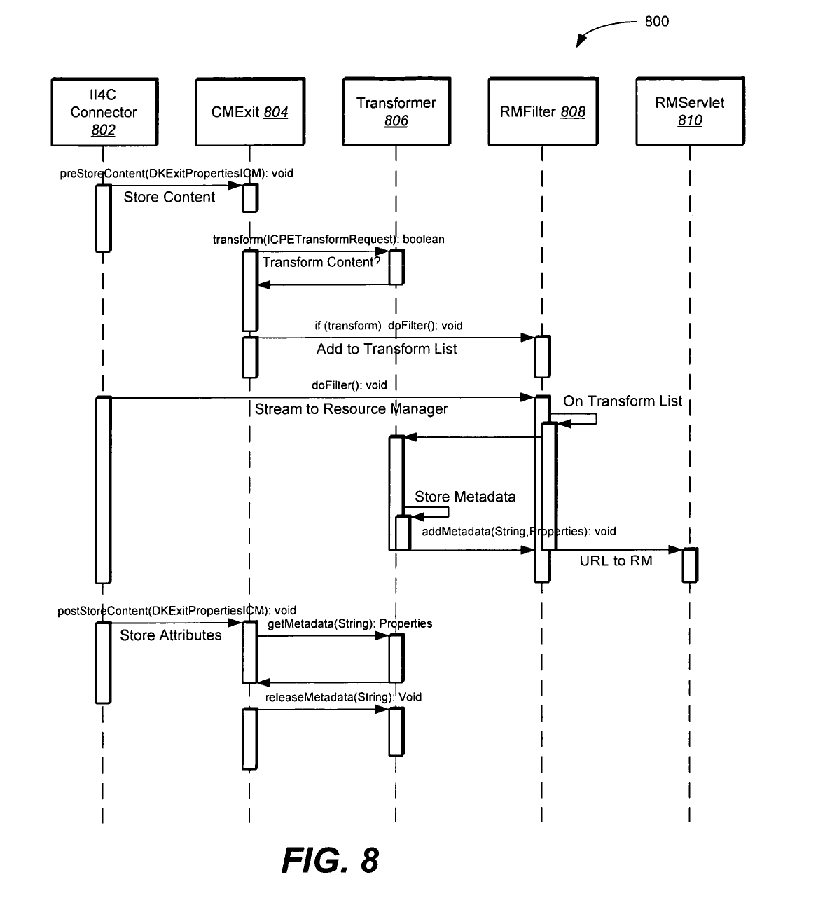

Referring to FIG. 8, a sequence diagram 800 is shown that illustrates method calls as digital content is imported into enterprise content management system 106 (FIG. 2) according to one implementation. The key components in sequence diagram 800 are the II4C connector 802, CMExit 804, transformer 806, RMFilter 808, and RMServlet 810. II4C connector 802 provides a Java interface layer to enterprise content management system 106. CMExit 804 represents software code that is called by II4C connector 802 whenever an import (or store) or an export (or retrieve) operations are performed. Transformer 806 is a service for transforming digital content. In one implementation, transformer 806 can also temporarily store transformed metadata. RMFilter 808 is a filter used to intercept all calls to resource manager 204 (e.g., filter 206 of FIG. 2). RMFilter 808 is the component that will call the transformation. RMServlet 810 is the serviet associated with resource manager 204.

As shown in FIG. 8, CMExit 804 uses transformer 806 to determine if digital content should be transformed, and if so, CMExit 804 communicates with RMFilter 808 to ensure that the digital content is sent to transformer 806. Specifically, II4C connector 802 first calls CMExit 804 when a request to import digital content into enterprise content management system 106 is received. CMExit 804 then calls transform 806 to determine whether the digital content needs to be transformed. Assuming that a transform of the digital content will be performed, CMExit 804 notifies RMFilter 808 about the impending import of the digital content. As discussed above, in one implementation, the digital content is captured as a stream or a URL to a stream before the data is stored, e.g., in resource manager 204. Accordingly, in one implementation, CMExit 804 notifies RMFilter 808 by obtaining the retrieve URL and adding the retrieve URL to an import alert command of RMFilter 808. CMExit 804 can invoke RMFilter 808 through a Hypertext Transfer Protocol (HTTP) post request.

RMFilter 808 handles the import notify request, and storing of the content ID, object name, content version, collection ID, the library name, the update date, the token, an import command, and timestamps for expiring the notification. RMFilter 808 is then invoked with the import request, and performs a lookup (e.g., of the content ID repository) to determine if there is a matching transformation request. If there is a match, then the corresponding transformation process is invoked. Once the transformation of the digital content is complete, metadata generated from the transformation is stored using the content ID as the key. The transformed digital content URL is then provided to RMServlet 810. II4C connector 802 then calls the postStore method in the Exit class. The postStore method stores the metadata provided by transformer 806 (such as state) into, for example, library server 202 (FIG. 2). In one implementation, once the metadata is stored in library server 202, then the metadata is removed from the data store of transformer 806.

Mapping Service

Referring back to FIG. 5, in one implementation, content and user ID mapper 502 maps third party digital rights management IDs (or content IDs) that are associated with DRM protected content to a globally unique identifier (GUID) assigned to the same digital content by enterprise management system 106. In particular, digital rights management systems generally package (or encrypt) digital content and associate a key (or a unique identifier, also referred to herein as a content ID) with the packaged digital content. Digital rights management systems also maintain information (e.g., access control information) about the packaged digital content, and persist such information in a license server according to the key. Thus, for example, should a digital rights management system encounter packaged digital content, then the digital rights management system can relate the packaged digital content to persisted information in a license server is through the content ID associated with the digital content. In one implementation, when digital content is imported into enterprise content management system 106, enterprise content management system 106 also assigns a unique identifier (ID) to the imported digital content. Accordingly, with respect to DRM protected content that has been imported into enterprise content management system 106, content and user ID mapper 502 (in one implementation) relates the content ID of the digital content to the (globally) unique identifier (ID) assigned to the same digital content by enterprise content management system 106.

XACML Policy Service

In one implementation, XACML policy service 504 determines what type of rights are applied to digital content that has been imported into enterprise content management system 106. In genera, in one implementation, enterprise content management system 106 is operable to provide access control to digital content through privilege (or permission) bits. For example, rights that can be associated with digital content through privilege bits include rights to create (or import), retrieve, update (or revise), and delete digital content within enterprise content management system 106. XACML policy service 504 is operable to determine the rights associated with particular digital content based on the globally unique identifier associated with the digital content. The globally unique identifier can be used, for example, to access ACLs (within enterprise content management system 106) based on the user requesting the digital content to determine which privilege bits are asserted to determine rights associated with digital content.

For example, in a tethered mode, if a user desires to access digital content that has been protected (through enterprise content management system 106) in accordance with a given digital rights management system, a license server (associated with the given digital rights management system) will negotiate with XACML policy service 504 to determine whether user access rights to the particular digital content. In general, in the tethered mode, the rights for a user and content are assigned at the time the user opens the digital content. In contrast, in a non-tethered mode, the rights for a user and content are assigned at the time of packaging. In this example, XACML policy service 504 communicates with content and user ID mapper 502 to determine the globally unique identifier (GUID) associated with the content ID of the digital content to determine what rights are applicable for the user. In a non-tethered mode, XACML policy service 504 is operable to create a license for digital content stored in enterprise content management system 106.

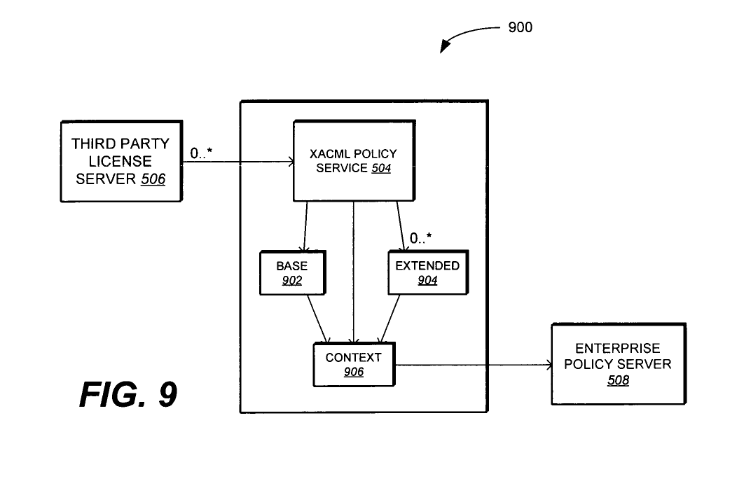

In one implementation, XACML policy service 504 provides XACML policy response information using a backend policy server (represented in FIG. 5 as enterprise policy server 508). Referring to FIG. 9, a block diagram 900 of XACML policy service 504 is shown in accordance with one implementation of the invention. In one implementation, XACML policy service 504 includes a base component 902, an extended component 904, and a context module 906. Base component 902 generates XACML response information using standard permission information received from enterprise license server 508. Extended component 904 adds information based on unique criteria. Extended component 904 permits flexibility so that third parties can alter the XACML response to include specialized information. Context module 906 abstracts the backend from base component 902 and extended component 904. A separate content module (not shown) would be required for each new backend. In one implementation, two specific types of XACML documents are generated by XACML policy service 504—an XACML policy and a XACML response.

An XACML policy includes the following. A set of rules, an identifier for rule-combining algorithms, a set of obligations, and a target. In one implementation, an XACML policy contains one target and any number of rules. A target can consist of three parts: subject, resource, and action(s). The rule can also contain a target, a set of conditions, and an effect. The effect is the intended consequence of the satisfied rule, and can take the value of “permit” or “deny”. The target helps determine whether or not an XACML policy is relevant to a request. The target may be broad, enabling several rules (or several actions within a rule) to be specified within a single XACML policy (in which each rule would concretely specify the target that applies to the rule). A rule can contain multiple actions. If more than one action is contained within a rule, the rules are evaluated disjunctively with respect to overall evaluation of the rule.

In one implementation, the target presents Boolean conditions that must be met in order for an XACML policy or rule to apply to a given request. If the policy and the rule apply, the rule is evaluated. When more than one rule applies, the rule-combining algorithm can be used to arrive at a final authorization decision. A rule can further include a condition. If a condition evaluates to true, the rule's effect is returned. If the condition evaluates to false, the rule does not apply and “Not Applicable” is returned for the rule. XACML policies can be combined into a policy set. The policy set specifies a policy-combining algorithm.

An XACML response (document) specifies a decision on an XACML request. In one implementation, the decision can be one of four values: Permit, Deny, Indeterminate, and NotApplicable. In addition, a status code can be returned which indicates whether errors occurred during evaluation of the XACML request. Possible values for the status code (in one implementation) are: ok, missing-attribute, syntax-error, processing-error, or other additional status information. In one implementation, the request for privileges and decisions takes the form of an XACML request. An XACML request specifies a subject (or subjects), a resource, and an action.

XACML policy service 504 can be called from transformer service 500 when integration with an un-tethered digital rights management systems occurs. In general, digital rights management systems have two possible patterns for integration, tethered and un-tethered. In the tethered case, digital content is securely packaged and a unique content ID is assigned to the package. The rights for a user and content are assigned at the time the user opens the digital content. Specifically, when the user (through a client) attempts to open the digital content, the user ID and DRM content ID are sent to a digital rights management policy server. The digital rights management policy either provides the rights, or requests rights from an enterprise policy service (e.g., XACML policy service 504). In the un-tethered case, the rights are assigned at the time of packaging. Depending upon the particular digital rights management system, rights may be determined from an enterprise list of templates, assigned by a user packaging the digital content, or from a policy server.

In one implementation, ACLs are associated with XACML policy service 504. In one implementation, the ACLs are in the form of a set of user IDs and/or user groups and their associated privileges. The privileges represented by an ACL can be represented through a privilege set, which is a collection of privileges. In one implementation, the ACLs are used to control access to digital content within enterprise content management system 106 (FIG. 2). For example, some of the objects that may be controlled through one or more ACLs include data objects (e.g., digital content stored by users) and item types. In one implementation, data objects have an assigned Persistent Identifier (PID). Thus, given a PID and a user name (or user ID), the privileges for the user on the specified data object can be determined. The ACL that is checked to control access to a particular item may come from either the item or the item type used to create the item. This is commonly known as item-level binding or item-level type binding. The item ACL and the item type ACL do not have to be the same. In one implementation, a mapping of an XACML policy to an ACL is as provided in table 1 below.

TABLE 1

| XACML Policy | ACL |
|---|---|
| subject | user |
| resource | PID |
| action | privilege |
| condition/action | attribute* |

*An XACML condition or action may be used as a qualifier for privilege. For example, if the privilege is “read”, then the qualifier may be “prior to 2005-09-28”. Or, if the privilege is “print”, then the qualifier may be “no more than (5) copies”. Accordingly, attributes can be used to represent qualifiers.

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

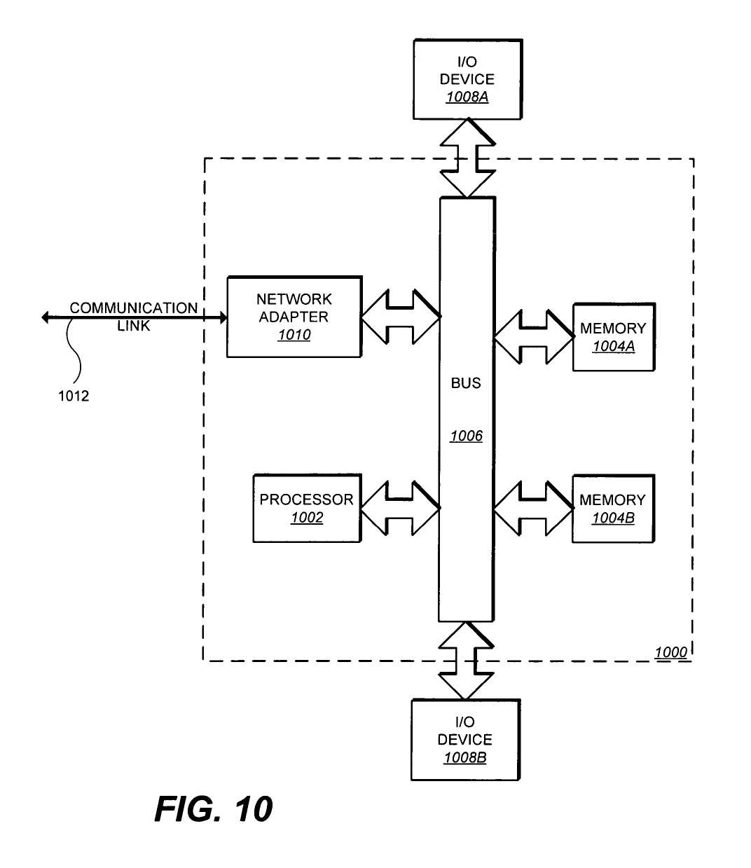

FIG. 10 illustrates a data processing system 1000 suitable for storing and/or executing program code. Data processing system 1000 includes a processor 1002 coupled to memory elements 1004A-B through a system bus 1006. In other embodiments, data processing system 1000 may include more than one processor and each processor may be coupled directly or indirectly to one or more memory elements through a system bus.

Memory elements 1004A-B can include local memory employed during actual execution of the program code, bulk storage, and cache memories that provide temporary storage of at least some program code in order to reduce the number of times the code must be retrieved from bulk storage during execution. As shown, input/output or I/O devices 1008A-B (including, but not limited to, keyboards, displays, pointing devices, etc.) are coupled to data processing system 1000. I/O devices 1008A-B may be coupled to data processing system 1000 directly or indirectly through intervening I/O controllers (not shown).

In the embodiment, a network adapter 1010 is coupled to data processing system 1000 to enable data processing system 1000 to become coupled to other data processing systems or remote printers or storage devices through communication link 1012. Communication link 1012 can be a private or public network. Modems, cable modems, and Ethernet cards are just a few of the currently available types of network adapters.

Various implementations for managing digital content in an enterprise content management system have been described. Nevertheless, one or ordinary skill in the art will readily recognize that there that various modifications may be made to the implementations, and any variation would be within the scope of the present invention. For example, the steps of methods discussed above can be performed in a different order to achieve desirable results. Accordingly, many modifications may be made by one of ordinary skill in the art without departing from the scope of the following claims.

What is claimed is:

1. A method for transforming digital content in a content management system, the method comprising:
automatically determining a first protected format of digital content that has been imported into the content management system; and
transforming the digital content from the first protected format into a second protected format, the second protected format being different from the first protected format.

2. The method of claim 1, further comprising storing the digital content in the content management system in accordance with the second protected format.

3. The method of claim 2, further comprising encrypting the stored digital content.

4. The method of claim 2, wherein storing the digital content includes storing the digital content in a plurality of different formats that correspond to a plurality of digital rights management systems supported by the content management system.

5. The method of claim 4, wherein storing the digital content includes storing the digital content in the clear to permit an index search or text search on the stored digital content.

6. The method of claim 5, further comprising exporting the digital content from the content management system in any one of the plurality of formats, including exporting the digital content in the clear.

7. The method of claim 1, further comprising applying a digital signature to the digital content imported into the content management system for authenticating the imported digital content.

8. The method of claim 1, wherein automatically determining a first protected format of digital content comprises applying one or more algorithms to the digital content to detect a characteristic that is unique to a digital rights management system.

9. The method of claim 1, wherein automatically determining a first protected format of digital content comprises applying one or more method calls, wherein each method call corresponds to particular digital rights management system supported by the content management system.

10. The method of claim 1, further comprising transcoding the digital content imported into the digital rights management from one format into another.

11. The method of claim 1, wherein transforming the digital content from the first protected format into a second protected format comprising using pre-established credentials established with digital rights management systems supported by the enterprise content management system.

12. The method of claim 11, wherein the pre-established credentials give the content management system one or more ownership rights in the digital content imported into the content management system.

13. The method of claim 1, wherein the digital content comprises one or more of HTML and XML Web content, document images, electronic office documents, printed output, audio, and video.

14. A computer program product, tangibly stored on a computer readable medium, for transforming digital content in a content management system, the product comprising instructions to cause a programmable processor to:
automatically determine a first protected format of digital content that has been imported into the content management system; and
transform the digital content from the first protected format into a second protected format, the second protected format being different from the first protected format.

15. The product of claim 14, further comprising instructions operable to store the digital content in the content management system in accordance with the second protected format.

16. The product of claim 15, further comprising instructions to encrypt the stored digital content

17. The product of claim 15, wherein the instructions to store the digital content include instructions to store the digital content in a plurality of different formats that correspond to a plurality of digital rights management systems supported by the content management system.

18. The product of claim 17, wherein the instructions to store the digital content include instructions to store the digital content in the clear to permit an index search or text search on the stored digital content.

19. The product of claim 18, further comprising instructions to export the digital content from the content management system in any one of the plurality of formats, including instructions to export the digital content in the clear.

20. The product of claim 14, further comprising instructions to apply a digital signature to the digital content imported into the content management system for authenticating the imported digital content.

21. The product of claim 14, wherein the instructions to automatically determine a first protected format of digital content includes instructions to apply one or more algorithms to the digital content to detect a characteristic that is unique to a digital rights management system.

22. The product of claim 14, wherein the instructions to automatically determine a first protected format of digital content includes instructions to apply one or more method calls, wherein each method call corresponds to particular digital rights management system supported by the content management system.

23. The product of claim 14, further comprising instructions to transcode the digital content imported into the digital rights management from one format into another.

24. The product of claim 14, wherein the instructions to transform the digital content from the first protected format into a second protected format includes instructions to use pre-established credentials established with digital rights management systems supported by the enterprise content management system.

25. The product of claim 24, wherein the pre-established credentials give the content management system one or more ownership rights in the digital content imported into the content management system.

26. The product of claim 14, wherein the digital content comprises one or more of HTML and XML Web content, document images, electronic office documents, printed output, audio, and video.

27. A content management system comprising:
a filter operable to automatically determine a first protected format of digital content that has been imported into the content management system; and
a transformer operable to transform the digital content from the first protected format into a second protected format,
wherein the second protected format is different from the first protected format.

28. The content management system of claim 27, further comprising a resource manager operable to store the digital content in accordance with the second protected format.

29. The content management system of claim 27, wherein the transformer is further operable to transform the digital content into a plurality of different formats that correspond to a plurality of digital rights management systems supported by the content management system.

30. The content management system of claim 29, wherein the transformer is operable to transform the digital content from the first protected format into the plurality of different formats using pre-established credentials established with digital rights management systems supported by the enterprise content management system.

31. The content management system of claim 29, wherein the resource manager is further operable to store the digital content in a plurality of different formats that correspond to a plurality of digital rights management systems supported by the content management system, and store the digital content in the clear to permit an index search or text search on the stored digital content.

32. The content management system of claim 31, wherein the content manager system is operable to export the digital content to a user in any one of the plurality of formats, including exporting the digital content to the user in the clear.

33. The content management system of claim 27, wherein the filter is operable to apply one or more algorithms to the digital content to detect a characteristic that is unique to a digital rights management system in order to automatically determine the first protected format of digital content.

34. The content management system of claim 27, wherein the filter is operable to applying one or more method calls to the digital content to detect a characteristic that is unique to a digital rights management system in order to automatically determine the first protected format of digital content, wherein each method call corresponds to particular digital rights management system supported by the content management system.

35. The content management system of claim 27, wherein the digital content comprises one or more of HTML and XML Web content, document images, electronic office documents, printed output, audio, and video.
